(19) United States
(12) Patent Application Publication
(10) Pub. No.: US 2012/0280577 A1
(43) Pub. Date: Nov. 8, 2012

(54) METHOD AND APPARATUS FOR TRANSMITTING DISCONTINUOUS MONOPOLARIZED ELECTRICAL ENERGY

(76) Inventor: Guillermo Garza Milling, San Pedro Garza Garcia (MX)

(21) Appl. No.: 13/510,735

(22) PCT Filed: Jul. 27, 2010
(86) PCT No.: PCT/MX10/00070

§ 371 Date: Jul. 24, 2012

(30) Foreign Application Priority Data
Nov. 19, 2009 (MX) MXA2009012503

(51) Int. Cl. H02J 3/00

(52) U.S. Cl. 307/146

(57) ABSTRACT

Method and apparatus for periodical transmission of electrical energy, with a high level of effectiveness, at low cost, with zero voltage times and heat dissipation times, using one or more alternating polarization electrical energy supply sources, to one or multiple destinations, with a form of electrical energy constituted by discontinuous monopolarized periodic sections, known as discontinuous transmission current, transmitted via transmission lines with zero voltage times and exclusive heat dissipation times, via electrical wires, for each polarity, across a transmission distance, with subsequent addition of the various discontinuous monopolarized sections, in direct form with no control, with no alteration to the qualities of the waveform and with no loss of energy or of the properties thereof in terms of the direct addition and delivery thereof, as alternating polarization periodic energy applicable to every type of voltage level, electric current density, alternating polarity waveforms and transmission length and frequency conditions.

### FIELD OF THE INVENTION

The field of the present invention corresponds to the transmission of periodic wave electric energy, more specifically, the transmission of electric energy of a monopolarized current, with high effectiveness, low cost, times of zero voltage and times of heat dissipation, as well, as the apparatus to achieve it.

### BACKGROUND OF THE INVENTION

The present invention is related with the background for the transmission of electric energy power over a distance of transmission.

The electric energy for its use as electric power, traditionally, has been transmitted in its form know as Alternating Current because of the sinusoidal form of the voltage wave in which said Alternating Current is generated.

Although it has always been known that the Alternating Current is not ideal for the transmission of electric power, because of the losses due to the magnetic fields induced by the intensity of the transmitted current, but without a doubt it has been the most used, because the generators as well as the apparatuses that consume the energy to work are designed for said Alternating Current.

Combined with that, the transformers that increase or decrease the voltage, work precisely with the variation of the current that circulated by its coil, that provokes a magnetic flow, making the Alternating Current indispensable.

If it was not the Alternating Current, as it is known by the specialists in the subject, there exists the Direct Current, that is not alternating in a sinusoidal form, but that it has a voltage wave of a singular uniform polarity, like a straight line, regularly accepted as always positive in its positive polarity, when dealing with the positive Direct Current voltage, or always negative in its negative polarity, when dealing with the negative Direct Current voltage, and it is conducted in lines, electrically insulated at all times, continually generating heat, and in most cases has a fixed instantaneous voltage value or one with a minimal variation from the average value in order to be considered as the continual voltage of a Direct Current.

The use of the electric energy from the Direct Current has increased with the advances in electronics and with new equipment generating electric energy such as the photovoltaic systems that generate Direct Current, to be used in motors and equipment suitable for Direct Current without any problem, but to use it in equipment of Alternating Current requires it to be transformed by means of electronic controllers known as Inverted Converters or Inverters, specifically made for that purpose, with the consideration that said Inverters significantly distort the form of the Alternating Current wave making it incomparable graphically and mathematically, that it has been accepted to use, assuming high costs, given the significant advantages of the transmission of electric energy as Direct Current, so as not to have losses of energy for the inductive effect of the Alternating Current, although it also has its disadvantages, of which the main disadvantage is the need for expensive equipment to convert Alternating Current electric energy into Direct Current energy for its transmission and vice versa to be used as Alternating Current, in addition to the problems derived from the transient events generated by the wave type that attempts to be like that of the Alternating Current, both disadvantages are overcome with the present invention.

The cost of the equipment has caused its use to be limited to a minimum percentage of the possible applications, because it can only be justified where the saving obtained by the reduction of the losses is higher than the cost of the equipment and its maintenance, and it is only justified in very long transmission distances or in electric currents with very high intensity.

In the transmission over long distances, the economic tendency has directed the technique towards searching for higher and higher levels of voltage with their respective lower levels of intensity of electric current, for an equal transferred electric power, to reduce the losses caused by the intensity of the electric current as said.

In the applications of electric current at high levels of intensity, associated with low levels of voltage, the transmission of the Direct Current has not advanced due to the high cost of the unidirectional valves for the conduction between those that exist, such as the Diodes and the Silicon Controlled Rectifiers among others, that in order to reduce limitations of conduction and their effect on the distortion of the waveform, have directed the technique towards modulation models with a wide pulse with greater generation of transitory voltage and higher component costs, that have been successfully applied in lower loads, regularly taking advantage of other properties derived from the control of the frequency that is out of the context of the present invention.

Antecedents of the rectification models, including half wave, single phase full wave, and three phase full wave rectifiers, all of them rectifying the form of the wave removing undulations, using multiple techniques to do so, from the capacitors to temporarily hold the energy that is given afterwards to smooth or rectify the form of the wave, distorting it, until the accumulation of the multiple half waves to generate a waveform more closely related to that of the Direct Current, techniques that cause the loss of the properties and qualities of the sinusoidal waveform of the Alternating Current as its principle objective.

Additionally, the rectifiers found in the state of the art do not remotely consider the possibility of inverting the distorted wave that is similar to that of a Direct Current to recover the sinusoidal waveform of the Alternating Current without distortions, having observed in the state of the art, many types of step waves and other waves modulated in the width of the pulse, all of them basically different, graphically and mathematically, from the sinusoidal form of the wave, for as much as it is wanted to be made the same, they are fundamentally different from the way the sinusoidal wave is formed.

Additionally, transmission systems of electric energy have not been found for the transmission of discontinuous electric energy, in the range of frequencies of the present invention, with exception to those used in radiofrequencies that are outside the reach of the present invention and that in fact do not come from a source of Alternating Current and do not have as their purpose to incorporate the wave into the original Alternating Current waveform without distortions.

For that reason, the Author of the present invention, was given the job of inventing the present method and apparatus for the purpose of drastically reducing the cost of the required equipment to make it economically feasible to transmit electric energy, with less loss of energy in the transmission, to be applicable to any distance for its cost reduction and with multiple benefits derived from that which there is no precedent until before the present invention.

Among the art patented regarding the transmission of electric energy under the traditional concepts of the Direct Current and the sinusoidal Alternating Current, different from the present invention because of the same nature of the waveform for the transmission of electric energy as is the distorted waveform as it has been accustomed to being called without being so, Direct Current and the step waveform as it have been accustomed to being called without being so, Alternating Current, we find U.S. Pat. No. 3,526,780 of Uhlmann, that offers us its art, very advanced for its time, although limited by the cost and the required capacity of the high voltage semiconductors required for the transmission of high voltage Direct Current electric power by two lines of Direct Current conductors, that include at least one converter station formed by at least one rectifier, and at least one inverter and its respective control systems for the delay angle of the rectifiers used on the rectifiers and on the inverters, mentioning two conductors of Direct Current and repeatedly making mention of the Voltage on the side of the Direct Current, which along with the drawings indicated that it concentrates the positive section of the Alternating Current voltage from the power source in the only line of positive direct current, and likewise concentrates the negative sections of the Alternating Current voltage from the power source in the only line of negative Direct Current, being differentiated from the present invention because in the present invention, the rectified half waves do not accumulated in the two lines of Direct Current, additionally they do not require an inverter or delayed angle controls.

The U.S. Pat. No. 4,019,115 of Lips, discloses an Energy Transmission System, with a common principle also called ring, for the Direct Current, that is fed from at least one source of three phase energy though rectifiers and has an output though multiple partial inverters placed in series to feed a Alternating Current circuit, concentrating all of the rectified half waves in two conductors, clearly defined in the drawings, where the multiple inverters connect, differentiated from the present invention because in the present invention the rectified half waves are not accumulated in two Direct Current lines, and they do not require inverters.

The U.S. Pat. No. 4,419,591 of Irokawa discloses a Direct Current power transmission systems with multiple terminals, using forward Converters and inverted Converters or Inverters, with their respective control units, which at the same time, include constant voltage control means, where it is established a relationship of magnitude if the different adjustment values of the voltage controls between the converter side and the inverter side, additionally including multiple means of constant energy control associated with the control units, showing in the drawings two terminals coming from the Direct Current Converters that are joined at a common point marked as point 23, from there to leave two terminals also of the same Direct Current to feed into an Inverter each one, as is shown, the terminals that represent the voltage of the Direct Current as is established in the drawings and labeled as the positive terminal and the negative terminal corresponding to the respective two lines of Direct Current where they are accumulated, the whole or partial, rectified half waves, art completely different from the purpose, configuration, method, and apparatus of the present invention that requires more than double the cost of equipment due to the need for controlled Converters and controlled Inverters, limiting the application and facing very high costs when dealing with high voltages, different from the present invention because it does not require inverted converters or inverters or voltage control means or current control, and it does not include a positive terminal and a negative terminal to take energy to the inverters.

The U.S. Pat. No. 7,518,266 of Eckroad discloses a system for the stability of a dispatch system or grid for an Alternating Current transmission system, that includes a transmission ring of Direct Current in the range of an Alternating Current transmission, isolating both transmissions and using the AC/DC converters to convert the Alternating Current into Direct Current with a waveform that has multiple undulations, DC/DC converters to insulate the transmission of electric power and DC/AC converters to convert the Direct Current's electric power into the Alternating Current electric power in a step waveform different from the sinusoidal waveform, such as is expressed in his Patent, completely different from the present invention, nevertheless, it is cited because it mentions Converters and the network of Direct Current in its topology to feed a central dispatch or local grid, requiring, different from the present invention, Direct Current to Alternating Current Converters with a wave form different from the sinusoidal and focusing on the topology and charge grid control and on the Direct Current in the same one, which are different from the present invention.

Paul E. Crowley in his U.S. Pat. No. 3,585,444 discloses the art to rectify the Alternating Current into half wave Direct Current, by means of a half wave rectifier to charge a capacitor with half wave cycles that distort them, for immediate use like that of a Direct Current, that was cited as Prior Art for using the half wave rectifiers mentioned in his drawings, although completely different from the present invention, because they distort the wave for its specific use, not to be transmitted nor to recover the original wave afterwards, attempting to correct or rectify a wave shape that is considered wrong to make it seem like another form of wave without undulations, the same distortions which are intentionally caused never could occur in nature.

Hewlett Jr. in his U.S. Pat. No. 3,610,961 discloses a control of the amount of energy to send a charge, using a Silicon Controlled Rectifier coming from an Alternating Current source, where the objective is to send a part of the half wave in accordance with the needs of a specific charge, that distort the half wave in the images of his Patent labeled with the number 7 in FIG. 2A, for his purpose, and not for transmission and that they don't recover the original Alternating Current waveform from the power source, differentiating it from the present invention, which it is cited to be an example of the Previous Art that used Silicon Controlled Rectifiers that are also unidirectional valves and are among the options for the present invention.

Wendell Neugebauer in his U.S. Pat. No. 2,862,118 discloses us his consistent art in a half wave rectifier for radio frequencies, that is not for the transmission of electric energy power that it was intended to be used as such, for its use with Alternating Current, although it uses half wave rectifiers similar to those of the present invention, only that now it is used with other purposes, where parallel resisters and capacitors are placed on the transmission line of half waves altered for radio frequencies.

In general all of the previous art found is, fundamentally, very different from the present invention because of the following structure of motives, which are: the waveform of the electric energy, and as has been previously expressed, in the past it has been accustomed to the Direct Current and the sinusoidal Alternating Current only, and in the present invention it is used as a transmission means of discontinuous mono polarized half waves, that allows types of cooling that are particularly critical in all of the contactors and as well allows times of zero voltage between the conductors and the ground, reducing the need for insulation of the transmission and allowing new technologies of insulation that will be developed as part of the present invention. Additionally is it also a difference in that previously it was considered two lines of Direct Current to accumulate all of the half waves of the Alternating Current, the positives with the positives and the negatives with the negatives, losing the main characteristic of each wave of the electric current upon distorting it, without taking into account the expensiveness of the recuperation of said characteristics, that in the present invention are not lost, nor do they limit the characteristics, upon the conservation of the waveform of each polarity without distorting it; additionally in the present invention, the half waves from the different stages stay separate, and are transmitted as Discontinuous Transmission Current or also called DTC, allowing multiple benefits. Additionally the different sections of the Discontinuous Transmission Current are rejoined given that they conserve their properties to form the original Alternating Current of the power source, with all of their qualities, without distortion, a characteristic unique to of the present invention; and lastly, the union of different sectors made directly by the physical and electrical union of multiple transmission lines, making that it so that Inverted Converters or Inverters are not needed to afterwards reunite the waves, as Alternating Current energy for its use, removing multiple sources of defect, persistent in the Alternating Current electric energy transmission systems, a significant advantage of the present invention.

In addition, the present invention is not limited to any specific type of wave, given the multiple possibilities that exist to maximize the efficiency of the transmission known in the present invention, to adequate it to multiple needs, that have been seen as limited in the past by the costs involved and because of not having in existence the present invention, being able to be applied to any type of periodic alternating wave, without requiring that the voltage level and that of the current of the positive polarity be equal to the negative polarity, or that that the frequency not be regular or uniform, conditions that in the past have fundamentally restricted the transmission of electric energy.

Among the specific technical advantages of the present invention, in addition to the cost and those already mentioned, we have the reduction of the capacitance that limits particularly the passage of the current of the submarine communication cables whose route of transmission is confined to a reduced space and lying at the bottom of the ocean, the transmission from point to point is optimized without the need to include throughout the path equipment that will increase the capacity of transmission, this thus is due to the decrease of losses and improvements in the amplification of the conductors, it reduces the cost of the conductors and the accessories, because of the interruption of the corona discharge. It facilitates the interconnection between regions of different standards and stabilization controls of its Alternating Current transmission networks and it also facilitates the synchronization of new generator plants, it facilitates the incorporation of systems that generate Direct Current electric energy such as photovoltaic cells, among others, given that they effectively contribute electric power that is directly compatible with the means of transmission, to recover afterwards the same Direct Current as well as to contribute electric power of the same charges of the Alternating Current that will be the topic of new technical works generated from the present invention.

Additionally, among the multiple advantages, the need for electric insulation is reduced, this facilitates the use of new means of electric insulation thanks to the zero voltage sectors of the Discontinuous Transmission Current, it avoids chain reaction failures in the synchronized networks of the Alternating Current, which is one of the main disadvantages that the Alternating Currents networks have, and it significantly reduces by more than half, the cost of the power electronics, compared with that needed in the Direct Current transmission systems. In a very important way, it reduces the need for the direct current voltage to pass zero so that it does not damage the interpreter contacts, additionally allowing them additional time to cool because of the discontinuity of the wave, versus the conventional Direct Current systems, and increases the reliability of the operation versus the Direct Current systems that use sophisticated power controls, which is one of the main criticisms of the Direct Current transmission systems, for its operation failures and the need for double redundancy in looking for a reliable practice.

In case of a failure of any of the possible multiple sources of energy connected to a network of Discontinuous Transmission Current in any of its polarities, by a decrease of the level of voltage given, it has less effect than in any Alternating Current system because its partial effect given the configuration of the present invention only affects one sector of the waveform, and, the overcharge applied to other sources to compensate for said decrease can be managed with an increased margin of time for its detection and the correction, the same principle that facilitates the incorporation of Direct Current energy sources switched to the transmission of the Discontinuous Transmission Current of the present invention.

All of the advantages previously mentioned with respect to the current systems, substantially make the present invention original, in addition to the significant reduction of costs increasing the range of application of transmission systems to shorter distances, and therefore, providing energy savings in multiples of the actual savings, with the Direct Current transmission systems of the past and with a high contribution to Ecology derived from the energy savings.

### BRIEF DESCRIPTION OF THE FIGURES

FIG. 1 shows a flow chart of the method for the high effectiveness and low cost electric energy transmission.

FIG. 2 shows a graphic representation of the standard wave form for Alternating Current electric energy against time that corresponds to the periodic sinusoidal wave.

FIG. 3 shows a representation of the periodic waveform selected with a positive polarity against time that we will call the Discontinuous Transmission Current with a positive polarity.

FIG. 4 shows a representation of the periodic waveform selected with negative polarity against time that we will call the Discontinuous Transmission Current with a negative polarity.

FIG. 5 shows a representation of the electrical symbol of a unidirectional flow valve that corresponds to the semiconductor element called Diode.

FIG. 6 shows an electrical symbol representing a unidirectional flow valve that corresponds to the semiconductor element called Silicon-Controlled Rectifier.

FIG. 7 shows an electrical symbol of a capacitor.

FIG. 8 shows an electrical diagram of an art of a one phase, half wave rectifier.

FIG. 9 shows an electrical diagram of an art of a complete three phase full wave rectifier.

FIG. 10 shows an electrical diagram of the apparatus of the present invention.

FIG. 11 shows the electrical diagram of the Apparatus of the present invention applied in multiple occasions, for a three phase with a neutral alternating current electric energy source.

FIG. 12 shows an one-line or single-line block diagram of the apparatus of the present invention.

FIG. 13 shows the application of the Apparatus of the present invention to feed three phase electric energy to the electric furnace.

FIG. 14 shows the application of the Apparatus of the present invention to feed three phase electric energy to a resistive, inductive, and capacitive charge.

FIG. 15 shows an one-line diagram, the application of the present invention to transmit electric energy in a network of transmission lines and multiple charges.

FIG. 16 shows a cross section of a the physical arrangement of the conductors that are necessary for the transmission of the three phase and neutral alternating current electrical energy with the method and the apparatus of the present invention, placed in longitudinal alignment.

FIG. 17 shows a cross section of the physical arrangement of the conductors that are necessary for the transmission of three phase and neutral Alternating Current electric energy, in a rhomboid type arrangement.

FIG. 18 shows an electrical diagram of the Apparatus of the present invention using contactors.

FIG. 19 shows an electrical diagram of the present invention, using unidirectional sectional controllers with multiple elements in series.

FIG. 20 shows an electrical diagram of the present invention, using unidirectional switch controllers with multiple elements in parallel.

FIG. 21 shows the side view of an outdoor unidirectional switch controller.

FIG. 22 shows a side view of a low cost installation of an outdoor unidirectional switch controller.

FIG. 23 shows an electrical diagram of the assembly that increases the electric power, connecting at the first point to the transmission line of the Discontinuous Transmission Current.

FIG. 24 shows an isometric view of the arrangement of the electrical conductors of the discontinuous transmission current between two towers.

FIG. 25 shows an electrical diagram of the assembly that lowers the electric power connected at a second point on the transmission line of the discontinuous transmission current.

FIG. 26 shows a cross section of the multiple horizontal physical assembly, for the placement of the conductors.

FIG. 27 shows a cross section of a front view of a multiple horizontal assembly with an outdoor insulator.

FIG. 28 shows a cross section of a multiple vertical physical arrangement for the placement of conductors.

FIG. 29 shows a cross section of a front view of a multiple vertical assembly with an outdoor insulator.

FIG. 30 shows a middle cross section of the multiple vertical assembly.

FIG. 31 shows a lateral view of the multiple vertical assembly.

FIG. 32 shows a front view of a tower with a first simple assembly, a second multiple horizontal assembly and a third multiple vertical assembly.

FIG. 33 shows a section of the transmission line with a multiple vertical assembly.

FIG. 34 shows a cross section of a discontinuous transmission current conductor.

FIG. 35 shows a cross section of a conductor with main electric insulation called a snowflake.

FIG. 36 shows an electrical diagram of the apparatus of the present invention with the unidirectional flow valves of the diode type to leave without reference to the inverse voltage with the conduction direction, to the contacts of the means of connection when the polarity is reversed.

FIG. 37 shows an electrical diagram of the apparatus for the transmission of electric energy with high effectiveness, low cost, and time for heat dissipation of the present invention with an arrangement of double vertical conductors.

### DETAILED DESCRIPTION OF THE INVENTION

The present invention refers to the need to transmit electric energy of periodic wave, alternating polarity and more specifically the alternating current of 60 cycles per second, without the present invention it is limited to that frequency, and also refers to a wave form that alternates from positive polarity to negative polarity and even more specifically refers to preferably the sinusoidal waveform, without being limited to this waveform or that the positive section of the wave be at the same level or in the same form as the negative section of the wave, or that it be at a fixed frequency, or at regular periods.

To achieve this, the present invention switches the alternating polarity periodic wave of electric energy from the source in a first positive section to transmit it separately, and in a second negative section to transmit it separately, to join them without control after the transmission, then, to integrate the original waveform with all of its properties.

In the field of application, the present invention is related with the transmission of high effectiveness electric energy, reducing the losses that are present during the trajectory of the transmission, as much for low voltage transmissions such as those used in the distribution and final use of the electric energy with low levels of electric power, to transmit, like those that use high voltage levels, that are used for long distance transmission, with huge levels of electric power, where the high effectiveness, low cost and the benefits of the zero voltage sectors and the sectors of heat dissipation can be noticed more.

The high effectiveness is achieved in the present invention upon improving the efficiency of the transmission by significantly reducing the losses by the induced magnetic fields that are present in the transmission of Alternating Current, because of the use of a select mono polarized, periodic wave for each conductor, to transmit separately with all of the qualities of the wave form, allowing sections of zero voltage and times of heat dissipation with its multiple benefits for the present invention and for future studies and inventions that will be applied in the future.

High effectiveness is also reached by reducing the costs of the equipment required by more than 50%, compared with the equipment needed to transmit Direct Current, as well as the optimization of the operating conditions of the means of connection, insulation and insulators, used in the applications of high and low voltage transmission.

In addition, the significant reduction of costs allows for the application of the present invention in fields never before imagined that were relegated to transmit electric energy with the lifetime losses by the magnetic fields generated by the fluctuation of the alternating current as are those of lesser distances of transmission that in the past did not justify the economic investment and therefore with the present invention make it possible.

Additionally, the present invention conserves the wave form of each mono polarized section with all of its qualities, to be able to be reintegrated after the transmission, without distortions for its optimal application.

The energy saving upon transmitting the electric energy more effectively, is applicable to a greater number of uses, with less costs and better operating conditions and with a wide variety of possibilities for new studies and inventions, they continue with the objectives of transmitting the energy with better efficiency, it is the purpose of the present invention that will be described hereafter.

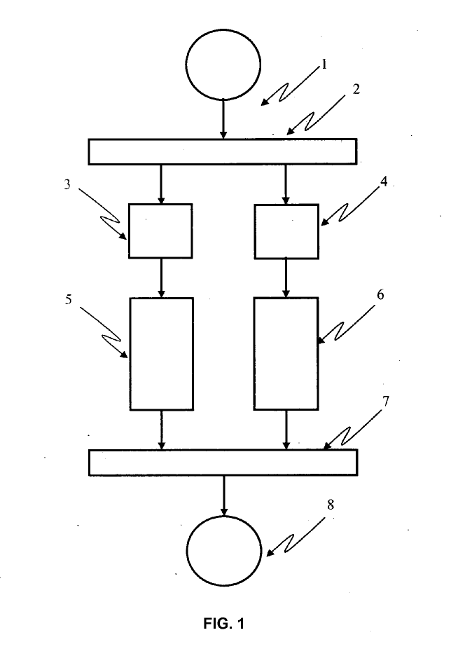

FIG. 1 shows the flow chart of the method for the transmission of high effectiveness and low cost electric energy, showing us a prior stage in the background art (1) that makes up a source of conventional alternating current electric energy, that gives its energy at an input port, as does the background art, from where the method of the present invention will begin, with; a first stage (2) that consists of, in a first connection means with times of heat dissipation, that connects the input of the alternating current electric energy to a first output to conduct only the positive electrical current, and a second output to conduct only the negative electrical current; a second stage (3) to connect the first output of the first means of connection, a first positive unidirectional switch controller to periodically switch the positive part of the alternating current wave, forming the positive discontinuous transmission current; a third stage (4) to connect the second output of the first means of connection, to a second negative unidirectional switch controller to periodically switch the negative part of the alternating current wave forming the negative discontinuous transmission current; a fourth stage (5) consists of the transmission of the positive discontinuous transmission current connected with the output of the first positive unidirectional controller though the second connection means with a means of electric energy conduction with times of zero voltage, transmitting it to one or multiple destinations of transmission; a fifth stage (6) consists of the transmission of the negative discontinuous transmission current connected with the output of the second negative unidirectional controller through a second connection means, with a means of electric energy conduction with times of zero voltage, transmitting it to one or multiple destinations of transmission; a sixth stage (7) consists in adding the positive discontinuous transmission current in a direct addition and energy delivery port, with the negative discontinuous transmission current, afterwards connecting physically and electrically though a third connection means the positive discontinuous transmission current, with the negative discontinuous transmission current optimally forming an alternating current wave, with no method of control, with all of the qualities of the wave form from the alternating current source of energy, to be delivered for its use, finishing the method of the present invention; and a subsequent stage of background art (8) that consists of connecting a conventional electrical charge, as in a previous art, for the use of the transmitted energy.

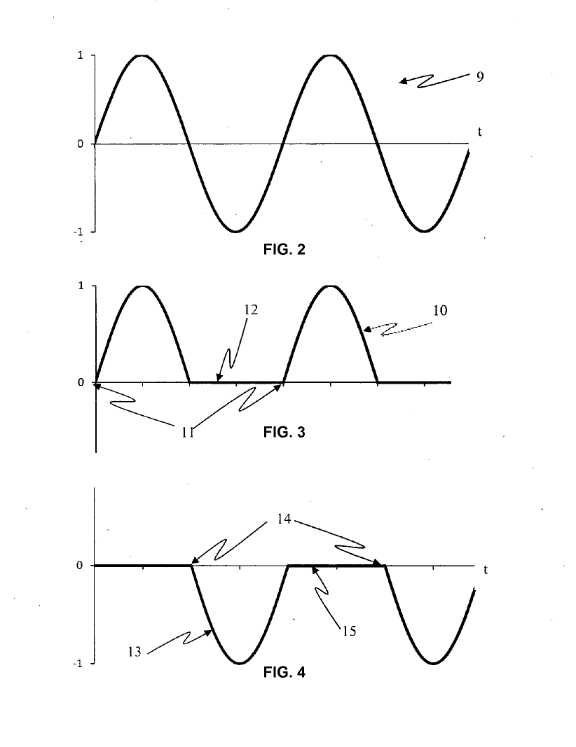

FIG. 2 shows the graphic representation of the standard waveform for alternating current electric energy against time, that corresponds to the periodic sinusoidal wave (9) that is mentioned as an example but is not limited to it, because it has been the periodic wave used the most to transmit electric energy, until before the present invention, with half of its wave being in the positive polarity region and the complimentary form of the wave, in the negative polarity region, without having equality between magnitudes in both polarities being a limiting characteristic of the present invention.

FIG. 3 shows the representation of the separated periodic wave with a positive polarity against time (10), that we will call Discontinuous Transmission Current, in the positive polarity, that makes the initial point of the periodic cycle (11) and the sector that does not conduce electric energy (12).

FIG. 4 shows the representation of the negative separated periodic wave against time (13), that we will call the Discontinuous Transmission Current, with negative polarity, that makes up the starting point of the periodic cycle (14) and the section that does not conduct electric energy (15).

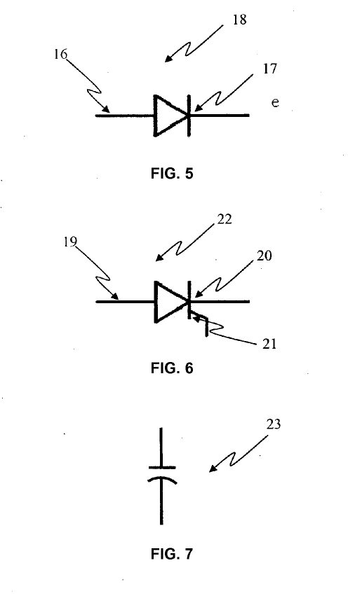

FIG. 5 shows the electronic symbol representation of a unidirectional flow valve that corresponds to the semiconductor element called the diode (18), for being one of the appropriate unidirectional flow valves for the present invention, without being limited to it, showing us a first terminal with a positive input (16) and a second terminal with a negative output (17).

FIG. 6 shows the symbolic electric representation of a unidirectional flow valve that corresponds to the semiconductor element called the Silicon Controlled Rectifier (22), that is also a second option of unidirectional conduction valves, without being limited to them, without having the purpose of the present invention being to rectify the undulations as if they were errors, but being the opposite, the purpose is to conserve the qualities of the electric energy wave to be transferred, although the name of the mentioned semiconductor does not honor the same purpose, showing us the positive terminal (19), the negative terminal (20) and the control port (21) to start the conduction when the polarity is correct.

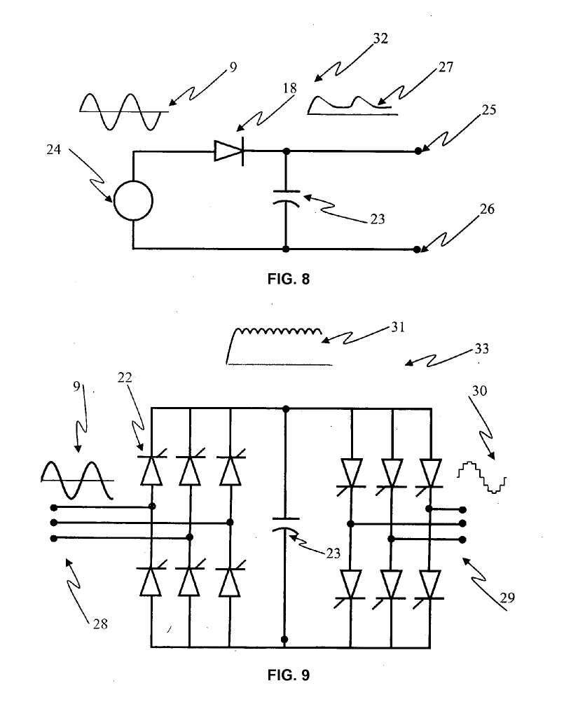

FIG. 7 shows the symbolic electric representation of a capacitor (23) highly used to alter the waveform of the current means of rectification of electric energy, distorting it.

FIG. 8 shows the electrical diagram of the background art of a half wave rectifier for one phase (32) that corrects by rectifying the complete wave to distort it with a capacitor for the purpose of making it seem more like a Direct Current or a Continuous Current that serves a very different purpose from that of the present invention, showing use the source of energy of the Alternating Current (24), the sinusoidal waveform of the example (9), the unidirectional switch (18), the distorting capacitor (23), the positive terminal (25) and the negative terminal (26), as well as the distorted waveform (27), all of which this give an example of a background art.

FIG. 9 shows the electrical diagram of a background art of an apparatus (33) that first converts three phase alternating current (9) of each one of its phases (28), in a waveform that accumulates multiple waves to distort them (31), attempting, without achieving it, to make it similar to the direct current that should have a uniform wave profile, to later reconvert it to its inverse form or invert it in a step wave of alternating polarity (30) to be delivered in the terminals of the output phases (29) that attempts to be similar to alternating current, although they are very different mathematically and graphically, using silicon controller rectifiers as unidirectional flow valves.

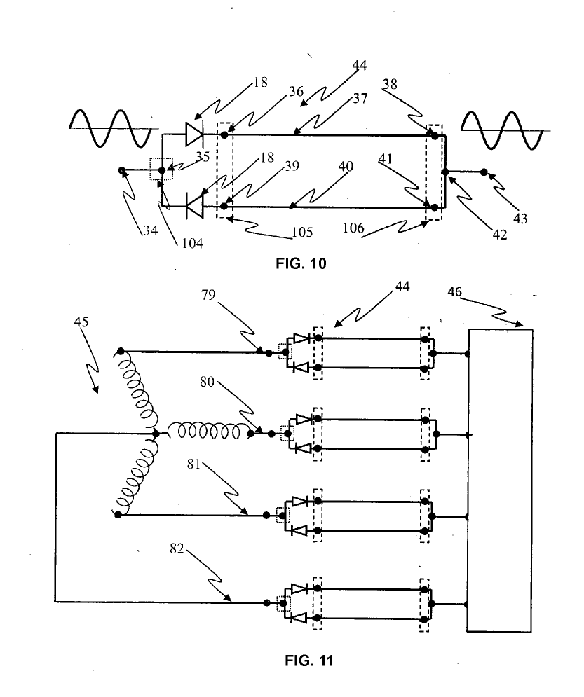

FIG. 10 shows the electrical diagram of the apparatus of the present invention (44), in which the source of electric energy delivers a sinusoidal wave that we will use as an example, to the input port (34) to feed into the connection (35) of the first means of connection (104) with time exclusively for heat dissipation, to be conducted to the first unidirectional switch controller, of discontinuous mono polarized energy (18) in its positive terminal, to be switched into positive discontinuous transmission current, as is shown in the upper part of the diagram, delivering the electric energy at its negative output to the first connection (36) of the second connection means (105), with specific times of heat dissipation, and afterwards, also, to be conducted to the second switch controller, of discontinuous mono polarized energy (18), at its negative output, in the bottom part of the diagram to switch it to negative discontinuous transmission current, and deliver the energy to its positive input on the second connection (39) of the second connection means (105), in which both connections (36) and (39) of the second connection means (105), deliver energy to the electrical conductors (37) and (40) respectively, which serve as transmission lines, with times exclusively for heat dissipation and with sections of zero voltage, to transmit the electric energy of the discontinuous transmission current, a distance until the connections (38) and (41) respectively, of the third connection means (106) with times exclusively for heat dissipation, at the end of the transmission lines to connect to outputs (38) and (41) of the third connection means with the direct addition and energy delivery port (42), physically and electrically joining the positive and negative discontinuous transmission currents, periodically, optimally to be delivered to terminal (43) of the alternating current with all of the properties of the original wave form from which they were switch previously, with the same waveform.

FIG. 11 shows an electrical diagram of the apparatus of the present invention, applied in multiple situations, for a source of three phase and a neutral alternating current electric energy (45), with a first phase (79), a second phase (80), a third phase (81) and a neutral (82), a unidirectional switch controller (44) for each phase and for the neutral and an electric charge (46).

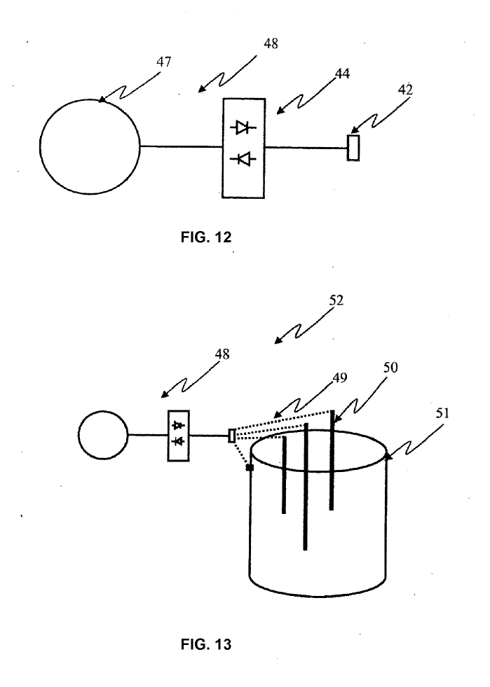

FIG. 12 shows a diagram of one line or single-line blocks of the apparatus of the present invention (48), with a source generating alternating current (47), the symbol for diagrams of one line or single-line of the switch controller (44) and the symbol of the direct addition and energy delivery port (42).

FIG. 13 shows a block diagram of the application (52) of the apparatus of the present invention to feed three phase electric energy to an electric furnace (51), in which the present invention (48) feeds the conductors (49) that go directly to the electrodes (50) inside the electric furnace structure (51) so that they use the energy for their specific purpose.

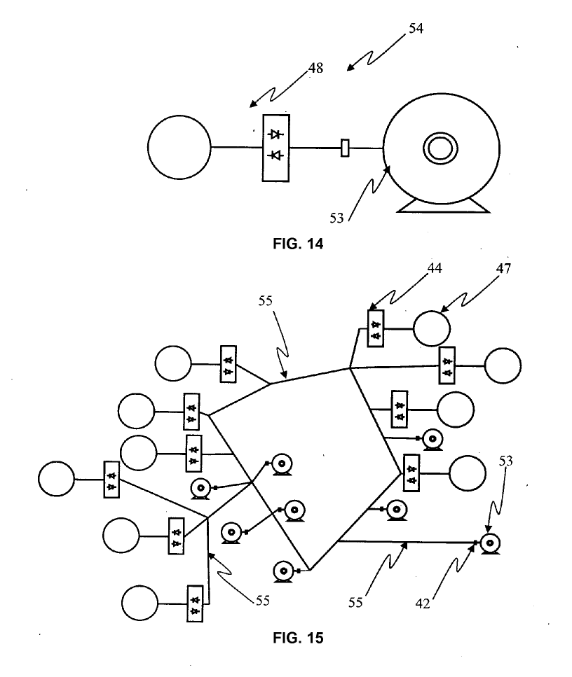

FIG. 14 presents a single-line diagram of the application (54) of the apparatus of the present invention to be fed by three phase charged electric energy, in which the present invention (48) feeds a specific resistive, inductive, and capacitive charge (53) as is illustrated.

FIG. 15 shows with a single-line diagram, the application of the present invention to transmit electric energy on a network of transmission lines and multiple charges, in which multiple sources of alternating current energy (47) feed the unidirectional switch controllers (44) to connect the positive discontinuous transmission current to the negative discontinuous transmission current to the network (55) that in multiple points have outputs to connect to the direct addition and input of energy port (42) to take the alternating current electric energy to multiple charges (53).

FIG. 16 shows a cross section of the physical arrangement of the conductors necessary for the transmission of three phase and a neutral alternating current electric energy with the method and the apparatus of the present invention, showing a conductor for each polarity, of each one of the three phases and of the neutral, all with discontinuous transmission current, in which is illustrated a first level of the three lines of transmission, placed in a row, with the conductor (56) that corresponds to the phase 1 positive polarity, the conductor (58) that corresponds to the phase 2 positive polarity and the conductor (60) that corresponds to the phase 3 positive polarity, a second layer that also has three transmission lines placed in a row, with the conductor (61) which corresponds to the phase 3 negative polarity, the conductor (57) which corresponds to the phase 1 negative polarity, and the conductor (59) which corresponds to the phase 2 negative polarity, and a third layer of two transmission lines placed in a row, which shows the conductor (62) that corresponds to the positive polarity of the neutral and conductor (63) that corresponds to the negative polarity of the neutral.

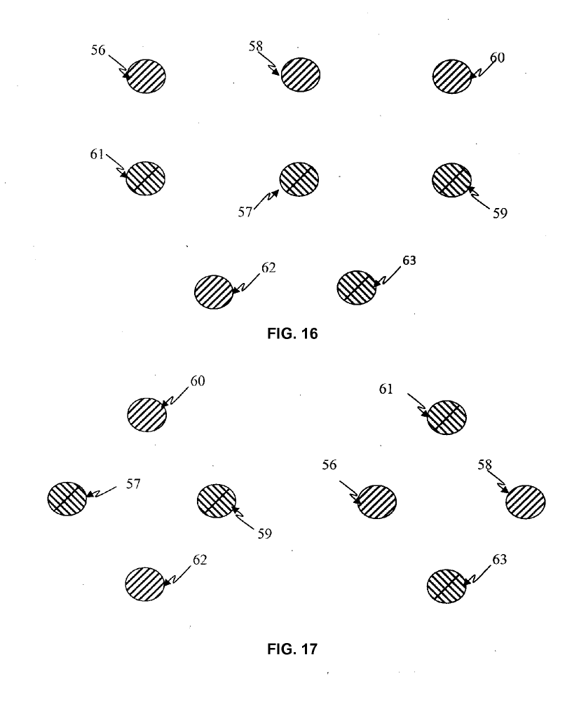

FIG. 17 shows a cross section of the physical arrangement of the conductors necessary for the transmission of three phase and a neutral alternating current electric energy with the method and the apparatus of the present invention, in the form of two rhombuses one beside the other, with the respective layers of conductors placed in rows with the following specific distribution of the different conductors that transmit discontinuous transmission current from a three phase and a neutral electric energy source, showing in the first rhombus on the left side, the upper conductor (60) that corresponds to the phase 3 positive polarity, in the second layer of the rhombus, the conductor immediately on the left side (57) that corresponds to phase 1 of the negative polarity, and the middle conductor of the right side (59) that corresponds to phase 2 of the negative polarity, and on the bottom part of the same left side rhombus, the conductor (62) that corresponds to the positive polarity of the neutral; in the second rhombus on the right side, the conductor in the upper part (61) corresponds to phase 3 negative polarity, on the second level, the middle conductor on the left (56) corresponds to phase 1 positive polarity, and the middle conductor on the right (58) corresponds to phase 2 positive polarity, and on the bottom part of the same rhombus on the left side, the conductor (63) that corresponds to the negative polarity of the neutral.

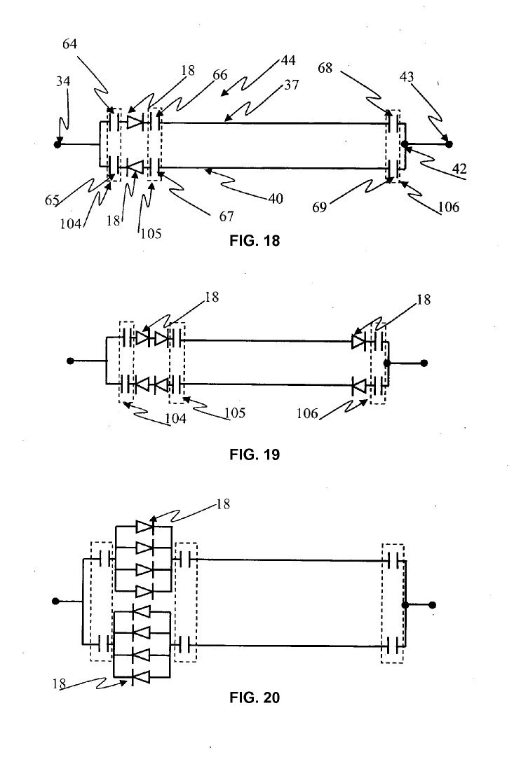

FIG. 18 shows an electrical diagram (44) of the apparatus of the present invention, from the input port (34) that receives the alternating current wave form to connect it to the first contact (64) of a switch as a first means of connection (104), with time exclusively for heat dissipation, and to the second contact (65) also of the switch as the first means of connection (104), a first unidirectional switch controller that is made of only one element (18) connected at its positive polarity with the first contact (64) of the first means of connection (104) in the upper part of the diagram and a second unidirectional switch controller, that is made of only one element (18) connected at its negative polarity with the second contact (65) of the first means of connection (104) on the bottom part of the diagram, a second connection means (105), with time exclusively for heat dissipation, to connect with the first contact (66) the output of the first unidirectional switch controller with the first line of transmission (37), with times exclusively for heat dissipation and sections of zero voltage, in the upper part of the diagram and, connected with the second contact (67), the output of the second unidirectional switch controller with the second line of transmission (40), with times exclusively for the dissipation of heat and sections of zero voltage, on the lower part of the diagram, a third connection means (106), with times exclusively for heat dissipation, connected in its first contact (68) with the first line of transmission and connected at its second contact (69) with the second line of transmission and both contacts (68) and (69) connected at their outputs with the direct addition and energy delivery port (42), periodically joining physically and electronically the positive and negative discontinuous transmission currents, optimally to deliver to terminal (43) the alternating current with all of the qualities of the original wave form from which it has been split previously.

FIG. 19 shows an electrical diagram of the present invention in the mode for the multiple element unidirectional switch controllers, showing the optimal placement with the switches as means of connection with times exclusively for heat dissipation, in an optimal arrangement for the transmission of the discontinuous transmission current with voltage levels above the resistance capacity of inverse voltage of the semiconductors used as elements of the unidirectional switch controllers, when it is required by the user of the present invention, making use of the multiple element semiconductors (18) to insulate the semiconductors from the effect of the inverse voltage in the terminals, as well as insulating each line of transmission electrically, with the complimentary polarity of the same phase, in the time period of the polarity, between a first semiconductor and a last semiconductor, it is inversed, upon not having voltage reference, during the path, to simplify the insulation and open new options for the development of selective insulators by polarity, for temporary operation that facilitate the arrangement and the placement of the lines in the high voltage transmission towers, and allow that since the first connection means, until the third connection means, there are times without voltage to facilitate its operation, to facilitate heat dissipation and the development of new periodic heat dissipation technologies, during said times of zero voltage.

FIG. 20 represents an electrical diagram of the multiple element semiconductor configuration (18) of the parallel unidirectional switch controllers, in the mode used when a semiconductor does not have the capacity to conduct the total of the electric current that is required in the application, dividing the current required by the charge between the parallel semiconductors, and in that way increasing its capacity of conduction together, the mode to use if the user of the present invention so requires it.

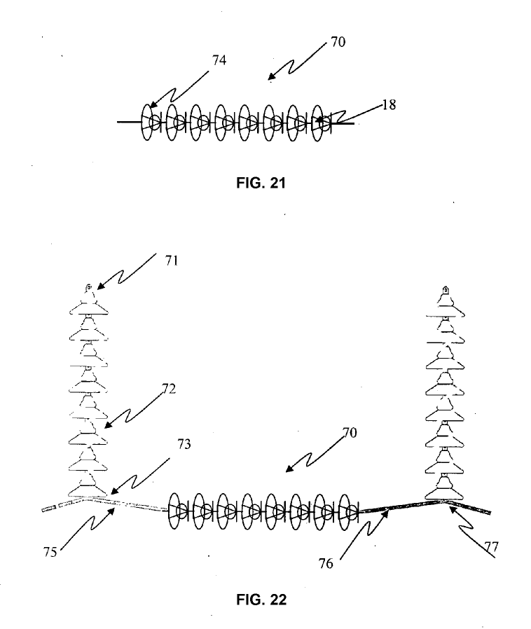

FIG. 21 shows a side view of an outdoor unidirectional controller, adapted with outdoor electric insulators adequate for high voltage and weather conditions, in which appear the semiconductor elements (18) on the interior of the insulators for the outdoors (74).

FIG. 22 shows the side view of a low cost installation of an outdoor unidirectional switch controller (70) placed between a first electric conductor (75), at its positive input and a second electric conductor (76) at its negative output, in the sense of the flow of the discontinuous transmission current, supported by a first insulated end (73) of the insulators and all of it supported by a second end of support (71), which is joined to the tower which gives support to the high voltage transmission lines, for the purpose of having a low cost installation which takes advantage of the self-insulation of the placement of the same conductors on a high voltage transmission line.

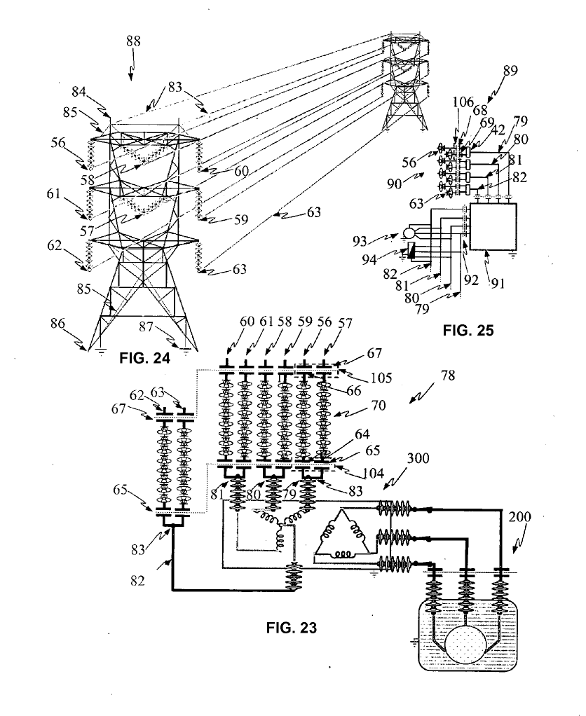

FIG. 23 shows an electrical diagram of the assembly in charge of the increase of electric (78) from a previous stage of the present invention, which makes up the three phase Alternating Current electric energy source (200) and a delta wye transformer with a neutral (300) to feed multiple ports of entry (83) with a first phase (79), a second phase (80), a third phase (81) and a neutral (82) with the Alternating Current electric energy, to start the present invention upon connecting a first means of connection of eight mono polarized lines (65), to conduct exclusively one polarity per each one of the contacts, allowing for times of heat dissipation, to deliver the electric energy to 8 unidirectional switch controllers, of the Discontinuous Transmission Current (70) which feed the second connection means (67) of eight mono polarized lines, to connect their outputs to a first point of the Discontinuous Transmission Current transmission lines, with a first conductor (56) of positive polarity and a second conductor (57) of negative polarity, both in the first phase, a third conductor (58) of positive polarity and a fourth conductor of negative polarity, both in the second phase, a first conductor (60) of positive polarity and a second conductor (61) of negative polarity, both in the third phase and a first conductor (62) of positive polarity and a second conductor (63) of negative polarity, both electric neutral, which connects an equal number of conductors identified with the same sequences and numbers on the support tower lines for the transmission lines, which are shown in the following figure.

FIG. 24 shows an isometric view of an arrangement of discontinuous transmission current electric conductors between two support towers (88) of high voltage electric energy transmission lines, which are connected by a first point with the assembly of increase of electric power (78) shown in the previous FIG. 23 and with a second point of group lowering of electric power (89) shown in FIG. 25 as follows the present figure; showing us the tower with the conductors of the first phase with a positive polarity (56) and with a negative polarity (57), the conductors of the second phase, with a positive polarity (58) and a negative polarity (59) and the conductors of the third phase with a positive polarity (60) and a negative polarity (61), and the conductors of electric neutral with positive polarity (62) and with negative polarity (63), a first tower of multiple towers (88) for the support of transmission lines with a structural support (86) for its foundation, at least one connection with the physical earth (87), at least one conductor (85) that connects to the physical earth (87) with the lightning conductor (84), connecting in its path the metal tower (88), and the lightning conductor (84) that are interconnected with multiple towers for the support of the transmission lines, through two guard lines (83) that join them electrically.

FIG. 25 shows an electrical diagram of an assembly to decrease the electric power (89) which connects to a second point of the discontinuous transmission current transmission line with arrangement of terminals (90) that starts with the terminal (56) and ends with terminal (63) in progressive numerical order already known to connect the eight transmission lines to the eight independent elements of the discontinuous mono polarized switches to insulate the inverse voltage of the transmission lines and to decrease its needs for insulation and to improve the possibilities of developing insulations that take advantage of the zero voltage, connecting the outputs of the independent elements, the four positive outputs with the four positive inputs (68) of the third connection means and the four negative outputs with the four negative inputs (69) of the third connection means of the eight mono polarized lines, to conduct exclusively one polarity through each one of its contacts, allowing times of heat dissipation, to connect the energy from the positive inputs and the negative inputs of each phase at the respective direct addition and energy delivery port (42) to form the alternating current electric energy with the original wave form in the three phases and the neutral, composed of a first phase (79), a second phase (80), a third phase (81) and the neutral (82), as the last stage of the method and apparatus of the present invention, to deliver alternating current to the substation (91) through its means of connection to feed at the output of the substation (91) the three phase and the neutral composed of the first phase (79), the second phase (80), the third phase (81) and the neutral (82), that distribute the alternating current electric energy though an arrangement of three phases and a neutral in that it connects directly to the charge (93) and an energy distribution center (94), mentioned as an example, without being limited to them, among other electrical charges.

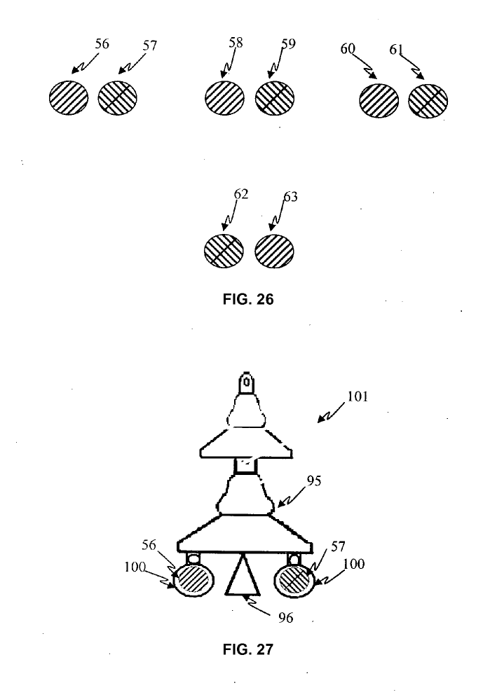

FIG. 26 represents a cross section of the physical multiple horizontal arrangement for the placement of the conductors necessary for a transmission of three phase and a neutral alternating current electric energy with the method and the apparatus of the present invention, showing a conductor for each polarity, each one of the three phases and the neutral, all with discontinuous transmission current, starting with conductor (56) of the first phase positive polarity, paired with the conductor (57) of the first phase negative polarity, the conductor (58) of the second phase positive polarity paired with the conductor (59) of the second phase negative polarity, the conductor (60) of the third phase positive polarity paired with the conductor (61) of the third phase negative polarity, and conductor (62) of the neutral positive polarity paired with the conductor (63) of the neutral negative polarity, in an arrangement to make efficient their placement given the advantages of electric energy conduction with times of zero voltage and the advantages of the placement of the independent units of the independent elements of the unidirectional switch controllers along the transmission lines, and the advantage of having conductors with times of zero voltage improves the conditions to apply new insulation means that take advantage of the sectors of zero voltage on the transmission lines.

FIG. 27 shows a cross section view of the front of a multiple horizontal (101) with an outdoor insulator (95) including its supports, showing a pair of conductors with horizontal alignment, a first conductor (56) and a second conductor (57) of the transmission line, that correspond to the two polarities of the same phase of the discontinuous transmission current, with an outdoor perimeter insulation (100), an insulation between the two (96) that prevents physical contact, of electric insulation capacity inferior to the electric insulation of the outdoor insulator (95) that supports it.

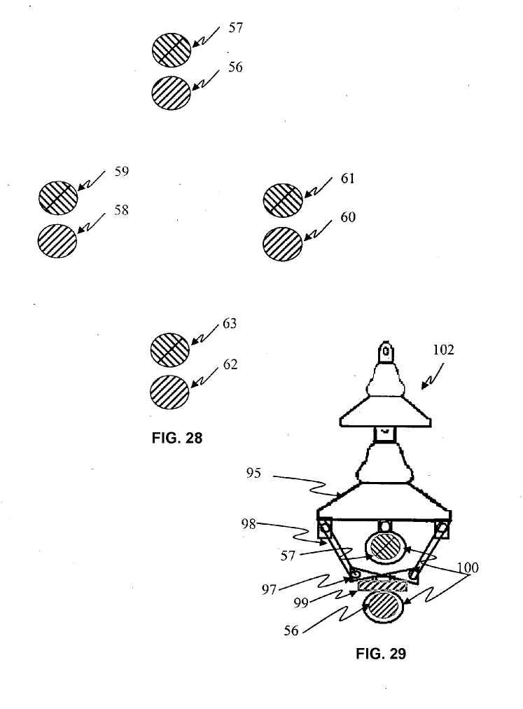

FIG. 28 represents a cross section of the physical multiple vertical arrangement for the placement of the conductors necessary for the transmission of three phase and a neutral alternating current electric energy with the method and the apparatus of the present invention, showing a conductor for each polarity, for each one of the three phases and the neutral, all with discontinuous transmission current, in an arrangement shaped like a rhombus so that pares of conductors are placed one above the other aligned vertically, showing a first conductor (57) and a second conductor (56) both in the first electrical phase on the first level, a second level with a first pair include the conductor (59) and the conductor (58) both of the second electrical phase and a second pair that include a first conductor (61) and a second conductor (60) in a third electrical phase and a third level with a pair formed by the first conductor (63) with a second conductor (62) of the electric neutral, arranged for the efficiency of the placement of the conductors, without being limited to it, given the advantages of the conduction of electric energy with times of zero voltage and the advantages of the placement of the independent units of the unidirectional switch controllers after the first means of connection and before the third connection means in the flow direction of the discontinuous transmission current.

FIG. 29 shows a cross section of the front view of a multiple vertical assembly (102) of an outdoor insulator (95) including its supports, showing a pair of conductors in vertical alignment, a first conductor (57) on the top and a second conductor (56) on the bottom, of the transmission line, that correspond to the two polarities of the same electrical phase, as an example of the discontinuous transmission current, with an outdoor insulator around the perimeter (100), a mechanism (98) that gives support to a first middle transverse insulator (97), below the upper insulator that supports it to support the lower conductor (56) a second longitudinal insulator (99) also that is between conductor (57) and conductor (56), to avoid that the two conductors have physical contact in the closeness of the support on the insulated side of the insulator (95).

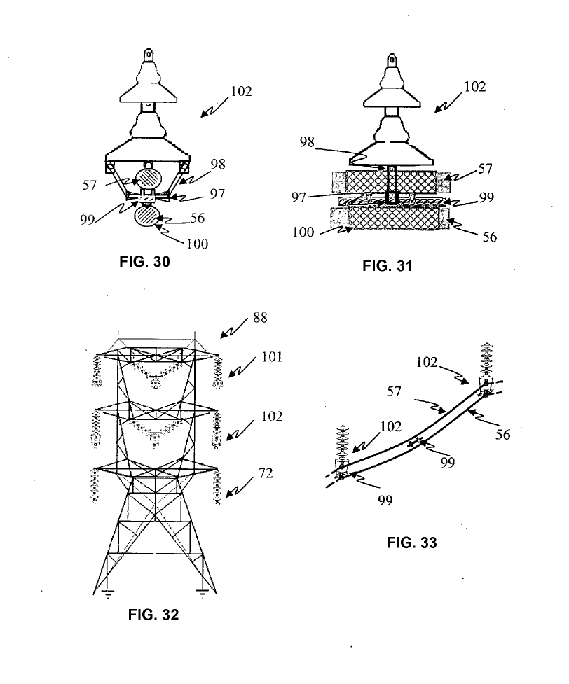

FIG. 30 shows a middle cross section of a multiple vertical assembly (102) of the representation of the previous figure, so that it serves as reference for the profile view of the same arrangement in the following figure.

FIG. 31 shows a lateral view of the multiple vertical assembly (102), showing the support of a first conductor (56) on the lower part and the support of a second conductor (57) on the upper part with an insulator around the perimeter (100) of each conductor, a transversal insulator (97) for support, held with the mechanism (98) with a longitudinal insulator (99) that prevents physical contact between the conductors (56) and (57).

FIG. 32 shows a front view of a support tower for the transmission lines (88) indicating a first arrangement of the insulator and support (72) for a single line of the discontinuous transmission current, a second arrangement that corresponds to the multiple vertical assembly (102), of the insulator and the support, showing the two conductors vertically aligned for the transmission of the discontinuous transmission current and a third arrangement (101) that corresponds to the multiple horizontal assembly, of insulator and support, showing two conductors horizontally aligned for the transmission of the discontinuous transmission current, as an example to the possible optimal arrangements according to the needs of the user of the present invention.

FIG. 33 shows a section of the transmission line with a first conductor (56) and a second conductor (57), in a multiple vertical arrangement, between the two insulators (102) of the support and the insulating, with insulating between the conductors (99) in proximity to the support on the insulated side of the insulators and with insulating between the conductors (99) between the lines of transmission.

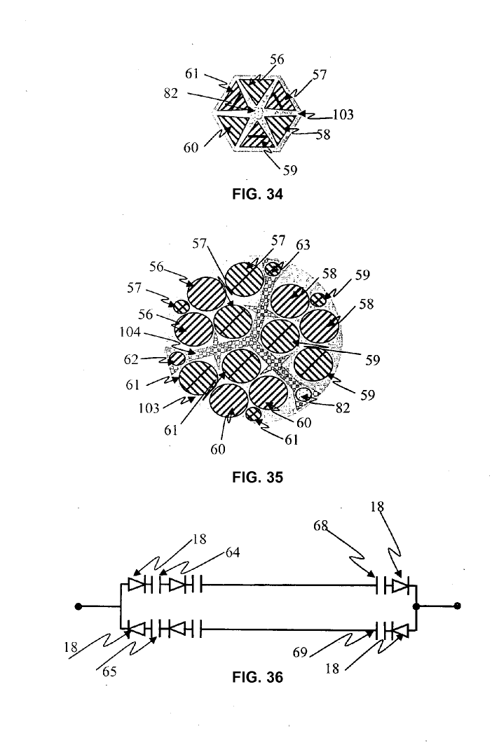

FIG. 34, shows a cross section of a discontinuous transmission current conductor, without being exclusively to the discontinuous transmission current, with six sections of conductors corresponding to low voltage transmission lines (56), (57), (58), (59), (60), and (61) and a neutral hub in the center (82), showing its physical arrangement, insulated between each, with a larger section of heat dissipation on the sides because of the temperature difference with the exterior, compared with the heat dissipation on its interior that finds heat conditions similar to that on the inside, and therefore needs greater electric insulation (103) to support said conditions, with the neutral (82) in the middle, that additionally serves for heat conduction.

FIG. 35 shows a cross section of a conductor for twelve main sections of conduction of electric energy and six secondary sections of lessor diameters, in which the physical arrangement and main electric insulation barriers (104), also called the snowflake, are shown along with the secondary electric insulation (103) for three groups of four principle conductors and a secondary conductor, in the first group of two main conductors (56), two conductors (57), and a secondary conductor (57) on the periphery, to share the current density of the main conductor (57) on the inside, that has less possibilities of heat dissipation, a second group of two conductors (58), two main conductors (59), and a secondary conductor (59) on the periphery, to share the density of the current from the main conductor (59) on the inside, that has less of heat dissipation, a third group of two conductors (60), two main conductors (61) and a secondary conductor (61) on the periphery to share the density of the current from the main conductor (61) on the inside that has less possibilities of heat dissipation, and three secondary conductors placed on the extremes of the main insulation (104), also called the snowflake, a first conductor (62) for the positive part of the neutral, a second conductor (63) for the negative part of the neutral and a third conductor (82) that groups the positive part and the negative part of the neutral, in which said grouping and electric separation by the main electric insulation also called the snowflake, is due to the regions that define said main electric insulation, are precisely where said insulation is required such that with the advanced configuration of the present invention, there exists a minimum need of insulation between the conductors of the same phase and of different polarities.

FIG. 36 shows an electrical diagram of the apparatus of the present invention with unidirectional flow valves of the diode type (18), the first ones placed after the input port and before the contacts (64) and (65) of the first connection means and the second ones before the direct addition and energy delivery port, and after the contacts (68) and (69) of the third connection means, to leave without reference to the voltage of the contacts of the connection means when the polarity is inverted to the sense of conduction.

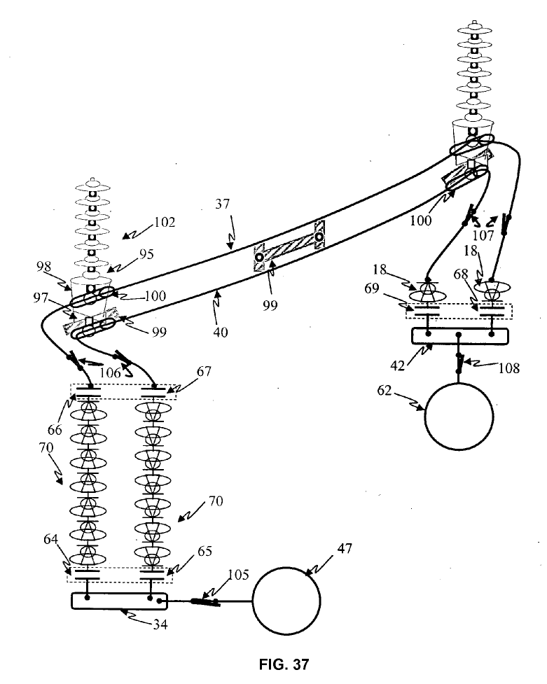

FIG. 37 shows an electric diagram of the apparatus of the present invention, from a source of alternating current electric energy (47) that feeds into an input port (34), connected through an isolator switch without charge (105) with a first contact (64) of the first connection means and with a second contact (65) of the first connection means, that feeds a first unidirectional switch controller (70) of multiple elements, at its positive terminal, to switch the positive part of the alternating current wave and a second unidirectional switch controller (70) of multiple elements, connected at its negative terminal to switch the negative part of the alternating current wave, a second connection means, to connect with the first contact (66) the output of the positive wave of the first unidirectional switch controller, through the isolator switch without charge (106) with a first point of a first transmission line (37), and to connect with a second contact (67) the output of the negative wave of the second unidirectional switch controller, through some isolator switch without charges (106), with a first point on the second transmission line (40), where the transmission lines (37) and (40) are supported with a multiple vertical assembly (102) with an outdoor insulator (95), a mechanism (98), to support a first middle cross insulator (97), a second longitudinal insulator (99), an outdoor perimeter insulator (100), to cover each one of the transmission lines (37) and (40), with a longitudinal insulator between the lines (99), until a second point in the path in which a lower electric is connected, through some insulator switches without charge (107), connected, first, at least one element of the unidirectional switch controller (18) at its positive terminal with the transmission line that conducts the positive part of the switched wave, and connects, second, at least one element of the unidirectional switch controller (18) at its negative terminal with the transmission line that conducts the negative part of the switched wave, a third connection means that connects a first terminal (68) with the last output of the first of at least one element of the unidirectional switch controller (18) at its last output that conducts the positive section of the wave and a second terminal (69) with the last output of the second at least one element of the unidirectional switch controller (18) at its last output that conducts the negative section of the wave, a direct addition and energy delivery port (42) that afterwards takes the positive waveform delivered by the first contact of the third connection means (68) with the negative waveform delivered by the second contact of the third connection means (68), directly through no control, to form the alternating current waveform with all of the qualities of the alternating current waveform from which they were switched, and deliver them through the output of the direct addition and energy delivery port (42) through some insulator switch without charge (108) for its use in an electric charge (62).

### Embodiments

It is an embodiment of the present invention in which the connection means are directly connected in the terminals of the parts that make up the apparatus of the present invention.

It is an embodiment of the present invention that the connection means be high voltage switches.

It is also an embodiment of the present invention that the connection means be electromagnetic contactors that facilitate the connection and disconnection when necessary.

It is also a preferred embodiment of the present invention, if the user so requires, that a first connection means be connected with the input port, and the so called third connection means be connected to the direct addition and energy delivery port, have a unidirectional flow valve as the semiconductor element diode, among others, each one, place in its contacts in the terminal on the side feeding the energy from the alternating current electric energy source for the first and on the side of the direct addition and energy delivery port for the called third, so that the contact in its entirety remains without voltage reference in the opposite direction to that of its flow, and it facilitates the use of advanced cooling systems, also without voltage reference, with better conditions for its electric insulation.

It is also a preferred embodiment of the present invention that the apparatus of the present invention have multiple points of connection from other sources of discontinuous transmission current electric energy coming from other compatible energy sources.

It is also a preferred embodiment of the present invention that the apparatus of the present invention have multiple points where the discontinuous transmission current of electric energy is lowered to different levels of charge and application.

It is also a preferred method of the present invention that the multiple points of discontinuous transmission current of electric energy connection is lowered, using subsections of the discontinuous transmission current to integrate waveforms different from that of the alternating current, as could be the case of the charges in which its controllers discharge only discontinuous mono polarized current, without being limited to this type of waveform.

It is also a preferred embodiment of the present invention that the multiple points of connection that lowers the discontinuous transmission current of electric energy require the subsections of the discontinuous transmission current to integrate waveforms of a different frequency with respect to the frequency of the discontinuous transmission current, as could be the case of charges that its controllers discharge frequencies in multiples of the frequency of the transmission line, without being limited to them.

What is claimed is:

1. A method for transmitting discontinuous monopolarized electric energy, coming from a source of electric energy, that is made up of a periodic wave of electric energy with alternating polarity, an electric insulation component, an input port that works as a connection terminal for electric conductors that transport the electric energy for its use, said method comprising first to sixth connection stages:
said first connection stage comprising providing times exclusively for heat dissipation, that is made up of an input of alternating current, providing a first output to conduct an electric current of only positive polarity and a second output to conduct only negative polarity electric current;
said second stage comprising dividing the periodic alternating polarized electric energy in a first periodic section, of positive polarity of the period wave of alternating polarity, to form the positive discontinuous mono polarized periodic section;
said third stage comprising dividing the alternating polarized, periodic electric energy wave in a second periodic section, of negative polarity of the periodic wave of alternating polarity, to form a negative discontinuous mono polarized periodic wave section;
said fourth stage comprising n and transmitting with times exclusively for heat dissipation and zero voltage, a positive discontinuous periodic mono polarized section by at least one positive discontinuous electric energy conduction component, such as positive discontinuous transmission current, through a distance of transmission, starting in each period, to one or multiple destinations;
said fifth stage comprising connecting and transmitting, with times exclusively for heat dissipation and zero voltage, the negative periodic discontinuous mono polarized section, of at least one discontinuous electric energy conduction component, such as the negative discontinuous transmission current, over a transmission distance, starting exactly in each period, to one or multiple destinations;
and said sixth stage comprising connecting and subsequently adding the positive periodic discontinuous mono polarized section with the negative periodic discontinuous mono polarized section, directly with no means of control, in at least one direct addition and energy delivery port, after the transmission, to deliver the same alternating polarized periodic electric energy waveform from which they were separated.

2. The method as claimed in claim 1, wherein the division of the positive section of the periodic wave of alternating polarity electric energy, that is carried out by at least one valve that allows unidirectional flow, connecting its positive input of periodic, alternating polarity, electric energy to conduct only the positive discontinuous periodic mono polarized section, periodically.

3. The method in accordance with as claimed in claim 1, wherein the division of the negative section, of the alternating polarity periodic electric energy wave, that is carried out through at least one valve that allows for unidirectional flow, connecting its negative input of the alternating polarity periodic electric energy, to conduct only a negative discontinuous periodic mono polarized section, periodically.

4. The method as claimed in claim 1, wherein the transmission of the positive periodic discontinuous mono polarized section, carried out through at least one of electric energy conduction component with times of zero voltage and times of heat dissipation, from one or multiple points of start, until any point or multiple points on a path of transmission, starting each period of transmission with high effectiveness, with zero magnetism induced by the transmission itself, with optimal conditions for electric insulation because of the discontinuous nature that the zero voltage times have, and with times exclusively for heat dissipation, allowing the interconnection between other transmission lines of equal electrical characteristics and also those of non-excluding characteristics.

5. The method as claimed in claim 1, wherein the transmission of a negative discontinuous periodic mono polarized section, which is carried out through at least one of electric energy conduction component with times of zero voltage and times of heat dissipation, from one or multiple starting points, until any point or multiple points on the transmission path, starting each period of transmission with high effectiveness, with zero magnetism induced by the same transmission, with optimal conditions for the electric insulation because of its discontinuous nature it has times of zero voltage and times exclusive for heat dissipation allowing the interconnection with other lines of transmission whose electric characteristics are the same and also those of non-exclusive characteristics.

6. The method The method as claimed in claim 1, wherein the subsequent addition of the positive discontinuous periodic mono polarized section with a negative discontinuous periodic mono polarized section directly, with any control component, in at least one direct addition and energy delivery port, after the transmission, adding the divided sections, periodically, to integrate the alternating polarity, periodic electric energy wave, from which they were divided.

7. An apparatus for transmitting discontinuous monopolarized electric energy, that is made up of an alternating polarity electric energy source, an input port connected to the alternating polarity electric energy source, an electric insulation component, characterized by; a first connection component with time exclusively for heat dissipation, connected at its input with the input port; a first unidirectional switch controller, for the positive polarity, connected at its positive input with a first output of the first connection component with times exclusively for heat dissipation; a second unidirectional switch controller of negative polarity, connected at its negative output, with a second output of the first connection, with times exclusively for heat dissipation; second connection component, with times exclusively for heat dissipation, connected at its first input with the output of the first positive unidirectional switch controller, and connected at its second input with the input of the second negative unidirectional switch controller; a first transmission line of discontinuous transmission current electric energy of positive polarity, with times of zero voltage and times exclusively for heat dissipation, that make an electric energy conductor, connected at a first point with the first output of the second connection component with times exclusively for heat dissipation, for the positive polarity; a second transmission line of negative discontinuous transmission current electric energy with times of zero voltage and times exclusive for heat dissipation, that make up an electric energy conductor, connected at a first point with the second output of the second connection component with times exclusively for heat dissipation for the negative polarity; a third connection component, with times exclusively for heat dissipation connected at a first input with the second point of the first transmission line and connected at a second input with a second point of the second transmission line; and a direct addition and energy delivery port, connected at its input with the first output of the third connection component, with times exclusively for heat dissipation, and connected also at its input with a second output of the third connection component, with times exclusively for heat dissipation, to join them physically and electrically, delivered to its output, the Alternating Current electric energy, transmitted for its subsequent use.

8. The apparatus as claimed in claim 7, wherein the unidirectional switch controller, makes up at least one wave switch.

9. The apparatus as claimed in claim 8, wherein the wave switch is a unidirectional flow valve that is made up of at least one semiconductor element with one or more unions between its semiconductor materials, that allow for the unidirectional conduction, without being limited to semiconductor elements.

10. The apparatus as claimed in claim 9, wherein the multiple semiconductor elements are separated into independent units to divide and insulate from inverse voltage in the multiple independent elements, for the purpose of using them where the transmission voltage is greater than its capacity to support the inverse voltage of each unit separately.

11. The apparatus as claimed in claim 10, wherein the multiple independent units of semiconductor elements are distributed along the transmission path of the electric energy, of Discontinuous Transmission Current, between the first connection component, with times exclusively for heat dissipation and the third connection component with times exclusively for heat dissipation.

12. The apparatus as claimed in claim 7, wherein the first transmission line, of Discontinuous Transmission Current of electric energy, with times of zero voltage and times exclusively for heat dissipation, makes up at least one electric energy conductor, and at least one electric insulation component, that allows it to transmit the electric energy safely.

13. The apparatus as claimed in claim 12, wherein the electric insulation component is a cover highly resistant to electric energy conduction, at least during the period of effective conduction of Discontinuous Transmission Current, placed on the exterior surface, that allows it to rest on another surface safely, avoiding the electric energy being conducted through another means of undesired conduction component.

14. The apparatus as claimed in claim 12, wherein the electric insulation component is only some high voltage insulators, with resistance to conducting electric energy for voltages greater than 1,000 volts of Alternating Current and greater than 1,000 volts of Direct Current, in contact with the electric conductor on the insulated end, and placed until the other end at specific points along the transmission line path, that allow it to be held, and to be supported, on the other end, by a structure for high voltage electric energy transmission, avoiding conducting its electric energy to another undesired conductor.

15. The apparatus claim 14, wherein, the high voltage insulators, at the insulated end, hold the first lines of transmission and hold the second lines of transmission of different polarity, separated electrically, with an electric insulator between them with a total value less than the insulation of the electric insulations that holds them.

16. The apparatus as claimed in claim 12, wherein the electric insulation component that makes up sectors of highly electrically insulated materials, is placed between the conductors of the high voltage transmission lines, and located, in a first sector in contact with the supports and in a section along the path between the towers that hold them, interposing their physical contact.

17. The apparatus as claimed in claim 7, wherein the second transmission line, of Discontinuous Transmission Current of electric energy, with times of zero voltage and times exclusively for heat dissipation, is made up of at least one electric energy conductor, and at least one electric insulation component, that allows for the transmission of electric energy safely.

18. The apparatus as claimed in claim 7, wherein the means of electric insulation component is a cover highly resistant to the conduction of electric energy, at least during the period of effective conduction of Discontinuous Transmission Current, placed on the exterior surface of the electric energy conductor, that allows it to rest on another surface safely, avoiding the conduction of electric energy to another undesirable means of conduction component.

19. The apparatus as claimed in claim 17, wherein the electric insulation component comprises high voltage insulators, with resistance to the conduction of electric energy for voltages greater than 1,000 volts of Alternating Current and greater than 1,000 volts of Direct Current, in contact with the electric conductor of the insulated end and place by the other end at specific points along the path of the transmission lines that allow it to be held, and be supported on the other end, in a structure for the transmission of high voltage electric energy, avoiding its electric energy to be conducted by an undesirable means of conduction.

20. The apparatus as claimed in claim 19, wherein the voltage insulators on the insulated end, hold the first transmission line and hold the second transmission line of different polarities, separated electronically, with an electronic insulator between them with a total value of insulation less than the insulation of the electric insulators that hold them.

21. The apparatus as claimed in claim 17, wherein the electric insulation component comprises sectors of electrically highly insulating material, placed between the conductors of the high voltage transmission lines, and located in the first sector in contact with its supports and, in a second sector along the path between the towers that hold them, interposing their physical contact.

22. The apparatus as claimed in claim 7, wherein the direct addition and energy delivery port, comprises at least a first connector of input for the Discontinuous Transmission Current, transmitted by the first transmission line, at least a second input connector for the Discontinuous Transmission Current transmitted by the second line of transmission, at least an output connector for the Alternating Current and a physical and electrical connection between the multiple input and output connectors.

23. The apparatus as claimed in claim 7, wherein the connection component with times exclusively for heat dissipation, comprises electric energy switches that facilitate the electric connection and the electric disconnection, between at least one input point and at least one output point and conduct the electric energy only part of the time, allowing for heat dissipation during the time that it is not conducting electricity, letting it be heated by the conduction facilitating the generated heat dissipation.

24. The apparatus as claimed in claim 7, wherein the connection component with times exclusively for heat dissipation comprises connectors of electric energy.
